(19) United States
(12) Patent Application Publication
(10) Pub. No.: US 2021/0179898 A1
(43) Pub. Date: Jun. 17, 2021

(54) MOISTURE SENSITIVE HOT MELT COMPOSITIONS IN INDIVIDUAL FORMS

(71) Applicant: H.B. Fuller Company, St. Paul, MN (US)

(72) Inventors: Andrew R. Michel, Plymouth, MN (US); Mark S. Kroll, Arden Hills, MN (US); David W. Moorman, Woodbury, MN (US); Nolan T. Hanson, Minneapolis, MN (US)

(21) Appl. No.: 17/118,860

(22) Filed: Dec. 11, 2020

Related U.S. Application Data
(60) Provisional application No. 62/947,870, filed on Dec. 13, 2019.

(51) Int. Cl. C09J 9/00; C09J 5/06; C09J 157/00; C09J 11/08

(52) U.S. Cl. CPC C09J 9/00; C09J 5/06; C09J 2453/00; C09J 11/08; C09J 2423/04; C09J 157/00

(57) ABSTRACT

The invention features a moisture sensitive hot melt composition in individual forms, the individual forms including a core of moisture sensitive hot melt composition, and an outer shell comprising a thermoplastic polymer, wherein the individual forms include a sealed zone of the outer shell material, extending outward from the body of the individual forms, on at least two opposing sides of the individual forms.

This application claims the benefit of U.S. Provisional Patent Application No. 62/947,870 filed on Dec. 13, 2019, which is incorporated herein.

### BACKGROUND

The invention is directed to individual forms of moisture sensitive hot melt compositions.

Many types of hot melt compositions are available in individual forms (e.g. pillows, pellets, slugs, etc.). If the hot melt composition is tacky at room temperature, these forms can be coated (e.g. coextruded) with a second, tack free material to make them easier to handle.

In the process by which coated individual forms of hot melt adhesives are made, they are coated when molten. The individual forms are made and then passed through an extended cold-water bath to cool them down.

It was previously thought that moisture sensitive hot melts could not be formed into coated individual forms due to the water bath cool down—and the concern that the moisture sensitive hot melts would be deleteriously impacted while passing through the bath or worse have moisture absorbed into the product that could contaminate the product and significantly reduce its effectiveness during use in the end article.

Thus, moisture sensitive hot melt compositions are commonly supplied in cakes i.e. release lined cardboard boxes and at times further sealed in foil in an attempt to keep them dry.

### SUMMARY

In one aspect, the invention features a moisture sensitive hot melt composition in individual forms, the individual forms including a core of moisture sensitive hot melt composition, and an outer shell comprising a thermoplastic polymer, wherein the individual forms include a sealed zone of outer shell material on at least two opposing sides of the individual form.

In one embodiment, the individual forms are selected from the group consisting of a pillow, a sausage and a slug. In another embodiment, the outer shell is coextruded with the moisture sensitive hot melt composition. In one embodiment, the moisture sensitive hot melt composition is selected from the group consisting of remoistenable, repulpable, compostable, hygroscopic, pH indicating, moisture indicating and moisture absorbing. In a different embodiment, the moisture sensitive hot melt composition is selected from the group consisting of a hot melt wetness indicator composition and a hot melt moisture absorbent polymer composition.

In one embodiment, the moisture sensitive hot melt composition in individual forms includes an indicator selected from the group consisting of a pH indicator and a moisture indicator or alternatively an indicator selected from the group consisting of bromocresol green, bromophenol blue and leuco dye.

In another embodiment, the moisture sensitive hot melt composition in individual forms is a hot melt moisture absorbent polymer composition. In a different embodiment, the hot melt moisture absorbent polymer composition comprises from 10% by weight to 65% by weight of a moisture absorbent polymer.

In one embodiment, the outer shell has a Mettler Softening Point of no greater than 16.7° C. of the application temperature of the moisture sensitive hot melt composition. In a different embodiment, the outer shell includes from 2% by weight to 7% by weight, or even from 3% by weight to 6% by weight of the moisture sensitive hot melt composition in individual forms.

In a different embodiment, the individual forms each weigh from 5 grams to 1000 grams, or even from 15 grams to 400 grams. In one embodiment, the outer shell includes a thermoplastic polymer selected from the group consisting of styrene block copolymer and ethylene polymer.

In another embodiment, the sealed zone is at least 1 millimeters (mm) in length extending outward from the body of the form. In a different embodiment, the sealed zone is from 2 mm to 10 mm in length extending outward from the body of the form.

In a different aspect, the invention features coextruded individual forms of moisture sensitive hot melt composition, obtained by a process wherein the moisture sensitive hot melt composition (a) is pumped through a coextrusion head and wherein the outer shell (b) is coextruded with the hot melt composition (a) such that the outer shell surrounds the hot melt composition, and then separating the coextruded material into individual forms by a method selected from the group consisting of pinching, pressing and heat sealing.

The inventors have unexpectedly discovered that it is possible to produce moisture sensitive hot melt compositions in coated individual forms in which the coating can be formed without entrapping water and such that the coating protects the moisture sensitive hot melt composition from moisture in the environment.

### BRIEF DESCRIPTION OF THE DRAWINGS

FIG. 1 is a rough sketch of a moisture sensitive hot melt composition in an individual form (i.e. a pillow) including the body of the individual form (7) and two sealed zones (10) on opposing ends.

### DETAILED DESCRIPTION

The invention features a moisture sensitive hot melt composition in individual forms, the individual forms including a core of moisture sensitive hot melt composition, and an outer shell comprising a thermoplastic polymer. The individual forms include the body of the individual form and a sealed zone of shell material on at least two opposing sides of the body.

In one embodiment, the invention features a moisture sensitive hot melt composition in individual forms, the individual forms including a core of moisture sensitive hot melt composition selected from the group consisting of remoistenable, repulpable, compostable, hygroscopic, pH indicating, moisture indicating and moisture absorbing, and an outer shell comprising a thermoplastic polymer, wherein the individual forms include a sealed zone of outer shell material, extending outward from the body of the individual forms, on at least two opposing sides of the individual forms.

In another embodiment, the invention features a moisture sensitive hot melt composition in individual forms, and an outer shell comprising a thermoplastic polymer, wherein the individual forms include a sealed zone of outer shell material, extending at least 0.5 millimeters outward from the body of the individual forms, on at least two opposing sides of the individual forms, the individual forms each weighing from 10 grams (g) to 400 g, or even from 15 g to 1000 g.

The individual forms are preferably in the form of a large pillow but can alternatively be in the form of a pouch, sausage, slug, pellet or any other kind of shape.

The individual forms can vary in size. Each individual form can weigh from 3 g to 2000 g, from 5 g to 800 g, from 10 g to 400 g, from 15 g to 1000 g, from 300 g to 1000 g, from 30 g to 100 g, or even from 20 g to 75 g.

### Moisture Sensitive Hot Melt Composition

The moisture sensitive composition is a hot melt. It is not a liquid at room temperature, but rather sets over time to become semi-solid or solid at room temperature. The hot melt can be a pressure sensitive (i.e. have tack at room temperature).

To be applied, the moisture sensitive hot melt composition needs to be heated until molten and applied hot. The moisture sensitive hot melt composition gains strength, once it becomes a solid again, as it cools down to room temperature. The moisture sensitive hot melt composition can be applied at temperatures of from 79.4° C. (175° F.) to 177.8° C. (350° F.), from 93.3° C. (200° F.) to 162.7° C. (325° F.), or even from 107.2° C. (225° F.) to 148.9° C. (300° F.).

The moisture sensitive hot melt composition can interact with moisture to provide a function (e.g. moisture or pH indicating, moisture absorbing, repulpability, compostability, remoistenability, etc.) in its end use. Alternatively, the moisture sensitive hot melt composition can include hygroscopic polymers (polymers that tend to absorb moisture from the air) e.g. polyamides, polyesters, etc. For moisture, sensitive hot melt compositions such as these, the coating can provide protection from the environment prior to use.

The moisture sensitive hot melt composition can be selected from the group consisting of remoistenable, repulpable, compostable, hygroscopic, moisture indicating, pH indicating, and moisture absorbing.

The moisture sensitive hot melt composition can include polymers, tackifying agents, plasticizers, surfactants, waxes, fillers (e.g. clays, calcium carbonate, silica, etc.), acids (e.g. stearic acid, citric acid, etc.), pH indicators, moisture indicators, moisture absorbent polymers and additives (e.g. antioxidants, UV stabilizers, optical brighteners, fluorescing agents, anti-block materials, etc.).

The moisture sensitive hot melt composition can include a thermoplastic polymer, a tackifying agent and a plasticizer. The moisture sensitive hot melt composition can further optionally include a material selected from the group consisting of surfactant, pH indicator, moisture indicator and moisture absorbent polymer.

The moisture sensitive hot melt composition can be selected from a group consisting of hot melt wetness indicator compositions and hot melt moisture absorbent compositions.

The hot melt wetness indicator composition includes an indicator. The indicator can be selected from the group consisting of pH indicators and moisture indicators. The hot melt moisture absorbent composition includes a moisture absorbent polymer.

### Thermoplastic Polymer

Useful thermoplastic polymers can include, e.g., homopolymers, copolymers, terpolymers, and higher order thermoplastic polymers. Suitable classes of thermoplastic polymers include, e.g., olefin polymer (e.g., olefin homopolymers, copolymers and higher order polymers (e.g., ethylene vinyl acetate, polyolefins (e.g., polyethylene, polypropylene, metallocene-catalyzed polyolefins, and combinations thereof))), and combinations thereof; acrylates (e.g., alkyl acrylates and methacrylates (e.g., ethyl acrylate, ethyl methacrylate, ethyl n-butyl acrylate, butyl acrylate, butyl methacrylate, and combinations thereof)); elastomers (e.g., elastomeric block copolymers (e.g., styrene-butadiene-styrene, styrene-isoprene-styrene, styrene-ethylene/butylene-styrene, and styrene-ethylene/propylene-styrene), elastomeric polyolefins, and combinations thereof); thermoplastic polyesters (e.g. poly lactic acid based polymer, polyhydroxy alkanoate based polymer, etc.); polyamides; vinyl pyrrolidones, thermoplastic polyurethanes, combinations thereof and functional versions (e.g. maleic anhydride modified, acid modified, etc.) thereof.

Useful commercially available vinyl copolymers include, e.g., ESCORENE AD2528 ethylene vinyl acetate copolymers from ExxonMobil Chemical Company (Houston, Tex.), and ATEVA 2850 ethylene vinyl acetate copolymers from Celanese Corp. (Irving, Tex.). Useful commercially available elastomeric block copolymers are available under a variety of trade designations including, e.g., KRATON D and G block copolymers from Kraton Polymers LLC (Houston, Tex.) including KRATON G 1650, 1652, and 1657 styrene-ethylene/butylene-styrene block copolymers and VECTOR block copolymers from TSRC/Dexco Investment Corp. (Houston, Tex.) including VECTOR 6241A styrene-butadiene-styrene block copolymer and VECTOR 4211A styrene-isoprene-styrene block copolymer.

Useful commercially available polyolefins are available under a variety of trade designations including, e.g., REXTAC propylene-based polymers, ethylene-propylene copolymers, and butene-propylene copolymers available from Rextac LLC (Odessa, Tex.), VESTOPLAST alpha-olefin copolymers available from Evonik Degussa GMBH LLC (Germany), AFFINITY and ENGAGE linear ethylene alpha-olefin copolymers available from Dow Chemical Company (Midland, Mich.), and VISTAMAXX propylene-based polymers from Exxon Mobil Corporation (Irving, Tex.).

The composition can include at least 5% by weight, at least 10% by weight, at least 15% by weight, from 5% by weight to 75% by weight, from 5% by weight to 50% by weight, or even from 10% by weight to 20% by weight of a polymer.

### Tackifying Agent

Useful tackifying agents include, e.g., rosin-based tackifying agents including rosin acids, rosin esters, wood rosin, tall oil rosin, gum rosin, distilled rosin, hydrogenated rosin, dimerized rosin, polymerized rosin, and combinations thereof, natural and synthetic terpenes, and derivatives thereof, aromatic, aliphatic and cycloaliphatic hydrocarbon resins, mixed aromatic and aliphatic modified hydrocarbon resins, aromatic modified aliphatic hydrocarbon resins, and hydrogenated versions thereof, terpenes, modified terpenes and hydrogenated versions thereof, low molecular weight polylactic acid, and combinations thereof. Examples of useful aliphatic and cycloaliphatic petroleum hydrocarbon resins, including aliphatic and cycloaliphatic petroleum hydrocarbon resins having Ring and Ball softening points of from about 10° C. to about 140° C. (e.g., branched and unbranched C5 resins, C9 resins, and C10 resins and styrenic and hydrogenated modifications thereof), alpha-methyl styrene resins, and the hydrogenated derivatives thereof.

Useful tackifying agents are commercially available under a variety of trade designations including, e.g., the SYLVALITE series of trade designations from Arizona Chemical Company (Jacksonville, Fla.) including, e.g., SYLVALITE RE-100L, the FORAL series of trade designations from Eastman (Kingsport, Tenn.) including, e.g., FORAL 105-E gum rosins and FORAL AX-E rosin acid, the ESCOREZ series of trade designations from ExxonMobil Chemical Company (Houston, Tex.) including ESCOREZ 5400, ESCOREZ 5415, ESCOREZ 5600, ESCOREZ 5615, and ESCOREZ 5690, the WINGTACK series of trade designations from Cray Valley HSC (Exton, Pa.) including WINGTACK 86, WINGTACK EXTRA and WINGTACK 95, the PICCOTAC series of trade designations from Eastman Chemical Company (Kingsport, Tenn.) including, e.g., PICCOTAC 8095, and ZONATAC NG 98 and SYLVARES ZT 105 styrenated terpene resins available from Arizona Chemical Company (Dover, Ohio).

The moisture sensitive hot melt composition can include from 0% by weight to 60% by weight, at least 5% by weight, at least 10% by weight, from 5% by weight to 60% by weight, from 10% by weight to 55% by weight, or even from 15% by weight to 50% by weight of a tackifying agent.

### Plasticizers

Useful plasticizers include, e.g., liquid plasticizer (i.e., a plasticizer that is liquid at room temperature), solid plasticizer, and combinations thereof. Useful plasticizers include non-polar plasticizers and polar plasticizers. Useful non-polar plasticizers include hydrocarbon oils, mineral oil, paraffinic oil, naphthenic oil, polybutene, polyisobutylene and combinations thereof.

Useful polar plasticizers include phthalate plasticizers such as dioctyl phthalate and butyl benzyl phthalate, liquid esters (e.g., esters of citric acid, benzoic acid and dimer acid), benzoate plasticizers such as 1,4-cyclohexane dimethanol dibenzoate, diethylene glycol/dipropylene glycol dibenzoate and diethylene glycol dibenzoate, phosphite plasticizers such as t-butyl diphenyl phosphate, polyethylene glycol and derivatives thereof, vegetable and animal oils such as glycerol esters of fatty acids and combinations thereof.

Suitable commercially available liquid plasticizers are available under a variety of trade designations including, e.g., CALSOL 5550 and CALSOL 550 naphthenic oil from Calumet Specialty Products (Indianapolis, Ind.), Dry #1 castor oil from Vertellus Specialty Materials Inc. (Bayonne, N.J.). One example of a suitable commercially available solid plasticizer is BENZOFLEX 352, which is available from Eastman Specialties Holdings Corp. (Kingsport, Tenn.). Other useful plasticizers include the CITROFLEX series of plasticizers from Vertellus Specialty Materials Inc. and MACOL 206 EM, polyethylene glycol, from PPG Industries Inc. (Pittsburgh, Pa.).

The composition can include from 0% by weight to 50% by weight, from 2% by weight to 40% by weight, from 10% by weight to 30% by weight, or even from 2% by weight to 10% by weight of a plasticizer.

### Surfactants

Surfactants can be useful in the moisture sensitive hot melt composition.

The type of surfactant used is not limited and can include any number of surfactants including nonionic surfactants, amphoteric surfactants, neutral surfactants, alkyl benzene sulfonic acid and alkyl sulfonic acid surfactants and their corresponding salts like dodecylbenzene sulfonic acid ethoxylated alcohols, fatty alcohols, high molecular weight alcohols, sorbitan esters, ethoxylated sorbitan esters, ethoxylated esters, glycerol based esters, derivatized polymers (including block copolymers); anionic and cationic and amphoteric surfactants, alkoxylated alkylates and any combination thereof.

Suitable commercially available surfactants include NACCONOL 90G available from Stepan Company (Northfield, Ill.) and RHODACAL DS 10 available from Solvay Chemicals, Inc. (Alorton, Ill.).

### PH Indicators

The hot melt wetness indicator composition can include a pH indicator.

The wetness indicator used in the invention can change color in response to a change in pH thereby demonstrating the presence of, for example, water or saline. Acid-base wetness indicators are preferred because they change the color rapidly. Preferred indicators are those that change to a bright, vivid color.

Examples of useful indicator agents include Ethyl Red, Bromophenol Blue, Bromocresol Green, a mixture of Bromophenol Blue with Bromocresol Green, Gentian Violet Crystal, Phloxine B free acid, Phloxine B sodium salt, Methyl Violet, Malachite Green Acidic, Malachite Green Alkaline, Bromophenol Blue Free acid, Methyl Orange Resazurin, Ethyl Red, Bromocresol Green Free acid, Quinaldine Red, Bromocresol Purple Free acid, Thymolphthalein, Fuchsin, Nile Blue, Aniline Blue and Indigo Carmine.

The level of wetness indicator used in the invention is sufficient to provide an easily recognized color change when it is exposed to a fluid. For example, a useful level of the wetness indicator includes from 0.01% by weight to 10% by weight, from 0.05% by weight to 5% by weight, or even from 0.1% by weight to 2% by weight, of the total composition.

### Moisture Indicators

The hot melt wetness indicator can include a moisture indicator such as for example a leuco dye. The composition can include any suitable leuco dye. Useful classes of leuco dyes include, e.g., phthalide leuco dyes, triarylmethane-based leuco dyes, diphenylmethane-based leuco dyes, lactam-based leuco dyes, fluoran-based leuco dyes, and combinations thereof.

Useful leuco dyes include leuco dyes that are solid at room temperature including, e.g., leuco dyes in the form of particles. Leuco dye particles preferably are dissolved in the wetness indicator composition such that no particles are visible when the composition in the molten state is viewed with the naked eye.

Useful commercially available leuco dyes include the leuco dyes available under the trade designation N-102 from ESCO Co. LLC. (Muskegon, Mich.), Crystal Violet Lactone (CVL) from Shanghai Lucky B & C Technology Co. Ltd. (Shanghai, China), and BLUE 230 from Nagase Inc. (Japan).

The composition includes from 0.1% by weight to 10% by weight, from 0.25% by weight to about 10% by weight, from 0.5% by weight to 5% by weight, or even from 1% by weight to about 4% by weight of a moisture indicator.

### Moisture Absorbent Polymers

The hot melt moisture absorbent composition includes a moisture absorbent polymer.

The moisture absorbent polymer can be selected from a group consisting of super absorbent polymer (SAP), natural or chemically modified natural polymers like cellulosics such as CMC, chitosan, pectin, guar gum, starches or dextrins, collagens and gelatine and synthetic polymers like polyacrylic acid, poly vinyl alcohol/acetate, poly hydroxyalkyl acrylates and methacrylates, polyacrylamides, polystyrene sulfonates, polyvinyl pyrilidone, polyglycols, copolymers, grafts of such, copolymers or compositions of such.

The physical form of some moisture absorbent polymers is relatively small granules, typically particles with a diameter of about less than 100 microns and usually supplied in the form of a dry powder. Moisture absorbent polymers can be produced by conventional techniques like milling and their coarse size support safe handling in production, by minimizing dust formation.

The SAP useful in invention comprises a water-swellable, hydrogel-forming absorbent polymer capable of absorbing large quantities of liquids such as water, body fluids (e.g., urine, blood), and the like. Additionally, the SAP can retain such absorbed fluids under moderate pressures.

Superabsorbent polymers useful in the invention include, e.g., crosslinked acrylate polymers, crosslinked products of vinyl alcohol-acrylate copolymers, crosslinked products of polyvinyl alcohols grafted with maleic anhydride, cross-linked products of acrylate-methacrylate copolymers, crosslinked saponification products of methyl acrylate-vinyl acetate copolymers, crosslinked products of starch acrylate graft copolymers, crosslinked saponification products of starch acrylonitrile graft copolymers, crosslinked products of carboxymethyl cellulose polymers and crosslinked products of isobutylene-maleic anhydride copolymers, and combinations thereof. The superabsorbent particles preferably are spherical and have an average particle size of less than 100 microns.

Useful commercially available superabsorbent particles include, e.g., sodium polyacrylate superabsorbent particles available under the AQUA KEEP series of trade designations from Sumitomo Seika Chemicals Col, Ltd. (Japan). Also, available superabsorbent materials are LUQUASORB 1010 and LUQUASORB 1003 from BASF, Ludwigshafen, Germany.

The moisture absorbent polymer can be present in the hot melt moisture absorbent composition at from 1% by weight to 70% by weight, from 10% by weight to 65% by weight, or even from 45% by weight to 65% by weight.

### Colorants

The moisture sensitive hot melt composition can include colorant(s). Possible liquid colorants include water soluble colorants like direct dyes, acid dyes, base dyes, and various solvent-soluble colorants. Examples of colorants further include, but are not limited to, organic dyes, inorganic pigments, colored macromolecules, colored nanoparticles and materials.

### Outer Shell

The moisture sensitive hot melt composition in individual forms includes an outer shell.

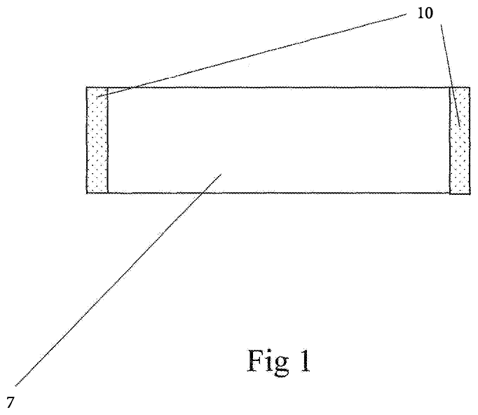

The outer shell includes a sealed zone, formed when the individual form is made. The sealed zone (FIG. 10) extends beyond the body (FIG. 1, 7) of the individual form to provide a moisture resistant barrier.

The sealed zone is present on at least two sides of the individual form, or alternatively can be present around the entire outside of the body of the individual form.

The sealed zone is substantially free of the moisture sensitive hot melt composition. The sealed zone is at least 0.5 millimeters (mm) in length (extending outward from the body of the form), at least 1 mm in length, at least 2 mm in length, from 0.5 mm to 20 mm in length, from 0.5 mm to 15 mm in length, from 1 mm to 12 mm in length, from 2 mm to 15 mm in length, or even from 2 mm to 10 mm in length.

The outer shell is hydrophobic to enable the formation of a moisture resistant barrier and further to allow for easy drying of the individual form after removal from the water bath.

The outer shell is a thermoplastic composition. The outer shell can consist entirely of one polymer, alternatively the outer shell can include other materials commonly used in hot melt compositions. Such materials include other thermoplastic polymers, tackifying agents, plasticizers, waxes, etc. Suitable types and amounts of these materials are listed above in the moisture sensitive hot melt composition section.

The outer shell can include a thermoplastic polymer selected from the group consisting of homopolymers, copolymers, terpolymers, and higher order thermoplastic polymers. Suitable classes of thermoplastic polymers include, e.g., olefin polymers (e.g., olefin homopolymers, copolymers and higher order polymers (e.g., ethylene vinyl acetate, polyolefins (e.g., polyethylene, polypropylene, metallocene-catalyzed polyolefins, and combinations thereof)), and combinations thereof; acrylates (e.g., alkyl acrylates and methacrylates (e.g., ethyl acrylate, ethyl methacrylate, ethyl n-butyl acrylate, butyl acrylate, butyl methacrylate, and combinations thereof) and elastomers (e.g., elastomeric block copolymers (e.g., styrene-butadiene-styrene, styrene-isoprene-styrene, styrene-ethylene/butylene-styrene, and styrene-ethylene/propylene-styrene), elastomeric polyolefins, butyl rubber and combinations thereof).

The outer shell can include a polymer selected from the group consisting of styrene block copolymer and ethylene polymer.

The outer shell is compatible with the moisture sensitive hot melt composition. By compatible it is meant that when the individual forms are used in the end application the coating does not interfere with the function of the moisture sensitive hot melt composition. By compatible it is further meant that the outer shell material doesn't phase separate from the moisture sensitive hot melt composition when tested per the Heat Stability Test Method.

The outer shell can have a Mettler Softening Point of no greater than 16.7° C. (30° F.), no greater than 11.1° C. (20° F.), or even no greater than 8.3° C. (15° F.) of the application temperature of the moisture sensitive hot melt composition.

The outer shell material comprises from 0.5% by weight to 10% by weight, from 0.5% by weight to 8% by weight, from 1% by weight to 7%, or even from 2% by weight to 6% by weight of the total weight of the individual form.

Suitable outer shell materials include ATEVA 1850A, an ethylene vinyl-acetate copolymer having a vinyl-acetate content of 18% and a MFR of 500 g/10 min (190° C., 2.16 kg) available from Celanese Eva Polymers (Irving Tex.) and Outer shell 1 (a hot melt composition found in the Examples section).

### Method of Making Individual Forms

The individual forms include an outer shell. The outer shell can be formed in several possible ways. Regardless of how the outer shell is formed, the outer shell includes a sealed zone. The inventors believe the sealed zone is critical to providing a coated moisture sensitive hot melt in individual forms where the moisture sensitive hot melt is well protected from the environment. The sealed zone seals the individual form in a more complete manner (as compared to for example a simple knife cut) to prevent moisture from penetrating through the fused portion of the coating and into the pillow.

The sealed zone can be made by separating the forms from each other in a specific manner. The sealed zone can be formed using any manner of separating that results in the sealed zone (e.g. pinching (e.g. by a pinch roller), pressing (e.g. by a heat sealer or a pressure seal).

In one method, the individual forms are made by directly pouring or pumping the molten moisture sensitive hot melt composition into a preformed plastic tube that can be cylindrical in shape. The plastic tube is preferably in contact with a heat sink to enable cooling. Methods such as this can be found for example in U.S. Pat. No. 5,373,682 which is incorporated herein by reference.

In another method, the individual forms are made by extruding the hot melt composition between sheets of film and then pressure sealing or heat sealing the film on all sides.

In another method, individual forms are made by coextruding the outer shell using a pillow packaging system such as for example those supplied by JPB Industry (Les Archards, France).

In the JPB type system, the molten moisture sensitive hot melt composition is coextruded with the molten outer shell directly into a cold-water bath.

As the coextruded composition comes out of the extruder, it is tube like in appearance. The coextruded tube immediately encounters a roller with two diametrically opposed rectangular shaped bars attached. Each rectangular shaped bar has an elevated portion along the center line bar that serves as a rounded knife. The rectangular shaped bars can have a width of around 0.492 millimeters (mm) (0.125 inch (in)) to 10 mm (0.393 in).

As the coextruded tube of material exits the extruder, the roller spins around and as the width of the bar hits the extruded tube it pinches it to form a seal of the co extrusion coating the width of the bar (a pinched zone) and separate it from one end of the tube. The pinched area is formed of two smaller pinched areas with a crease from the rounded knife separating the smaller sealed areas from each other. As the roller continues to spin, it forms a second seal on the opposite end of the pillow to form a second pinched zone and fully separate the pillow from the coextruded tube at the same time forming the first pinched zone of the next pillow.

The formed pillows then continue to advance through a water bath, to give the formed pillows the opportunity to cool down. After they are sufficiently cooled, they are slowly lifted out of the water bath by a strainer system and deposited onto a conveying belt where they are air dried by blowers and then dropped into a box for shipping.

### Uses

The moisture sensitive hot melt composition can interact with moisture to provide a function (e.g. repulpability, compostability, remoistenability, moisture or pH indicating, moisture absorbing, etc.) in its end use. Alternatively, the moisture sensitive hot melt composition can include hygroscopic polymers (polymers that tend to absorb moisture from the air) e.g. polyamides, polyesters, etc. For moisture sensitive hot melt compositions such as these, the coating can provide protection from the environment prior to use.

Moisture sensitive hot melt compositions can be used in a variety of applications. Moisture sensitive hot melt compositions such as those based on polyesters (e.g. poly lactic acid based polymer, polyhydroxy alkanoate based polymer, etc.) can be used for packaging (e.g. case and carton (construction or closing) or disposable article bonding and can be repulpable or even compostable after use. Remoistenable hot melts compositions can be used as a flap seal for various envelopes including tear off envelopes or foldable postcards. Moisture sensitive hot melt compositions based on hygroscopic polymers (e.g. polyamides, polyesters, etc.) can be useful for a variety of applications including those in various adhesive assembly applications (e.g. for bonding wood, plastic, etc.) and for bonding various textile materials.

The hot melt wetness indicator composition can provide a color signal when the composition has been contacted with an aqueous composition (e.g., water, urine, saline, and combinations thereof), which can signal to an observer that an article (e.g., a diaper) with which the hot melt wetness indicator composition is associated has been in contact with an aqueous composition (e.g., water, urine, saline, and combinations thereof). The hot melt wetness indicator composition can be applied on or incorporated in a variety of substrates including, e.g., films (e.g., polyolefin (e.g., polyethylene and polypropylene) films), release liners, porous substrates, cellulose substrates, sheets (e.g., paper, and fiber sheets), paper products, woven and nonwoven webs, fibers (e.g., synthetic polymer fibers and cellulose fibers), tape backings, components of absorbent articles including, e.g., absorbent elements, absorbent cores, impermeable layers (e.g., back sheets (e.g., polyolefin film back sheets)), tissue (e.g., wrapping tissue), acquisition layers and woven and nonwoven web layers (e.g., top sheets, absorbent tissue), labels, tapes, and combinations thereof.

The hot melt wetness indicator composition is also useful as a component in a variety of applications and in or on a variety of constructions including, e.g., disposable absorbent articles including, e.g., disposable diapers (e.g., adult incontinence diapers), training pants, incontinence pads, sanitary napkins, medical dressings (e.g., wound care products) bandages, surgical pads, drapes, gowns, and meat-packing products, paper products including, e.g., paper towels (e.g., multiple use towels), toilet paper, facial tissue, wipes, tissues, and towels (e.g., paper towels), sheets, mattress covers, packaging materials (e.g., boxes, cartons, trays, and bags (e.g., paper and polymeric)), and combinations thereof.

The hot melt moisture absorbent containing compositions are useful for a variety of end-uses including in the core of disposable absorbent articles such as disposable diapers, feminine napkins and medical dressings, to enhance absorbency of tissue, towels and surgical drapes, water swellable yarns and tapes for fiber optic cable wrap, as moisture barriers for wire and cable applications and a variety of agricultural applications targeted at increasing humectancy. The hot melt moisture absorbent containing compositions have further utility in packaging application for food and drugs for absorbing moisture and fluid, for building materials for preventing condensation and waterproofing.

Substrates to which hot melt moisture absorbent compositions are commonly applied to includes various film materials such as those employed as diaper back sheets and tape backings, absorbents such as wood pulp, paper, tissues and towels, nonwovens, and various cable components such as sheathing and jacketing materials.

Application Techniques

Various techniques for applying hot melt compositions can be used to apply the moisture sensitive hot melt composition to a substrate including, e.g., intermittent coating, continuous coating, slot coating, spraying including, e.g., spiral spraying and random spraying, screen printing, foaming, roller coating, engraved roller coating, wheel coating, extrusion (e.g., applying a bead, fine line extrusion, single screw extrusion, and twin screw extrusion), meltblown, noncontact coating, contacting coating, transfer coating, screen printing, flexographic, “on demand” application techniques, and combinations thereof.

### EXAMPLES

The invention will now be described by way of the following examples. All parts, ratios, percentages and amounts stated in the Examples are by weight unless otherwise specified.

NW1700 and NW1705 are both hot melt wetness indicator compositions available from HB Fuller Company (St. Paul, Minn.).

Viscosity Test Method

Viscosity is determined in accordance with ASTM D-3236 entitled, “Standard Test Method for Apparent viscosity of Hot Melt Adhesives and Coating Materials,” (Oct. 31, 1988), using a Brookfield Thermosel viscometer Model RVDV 2, and a number 27 spindle. The results are reported in centipoise (cP).

Humidity Resistance

Humidity resistance was measured by measuring the change in viscosity of the specified individual form after exposure to a high humidity environment. Change in Viscosity is determined by taking the initial viscosity of the material at 121° C. (cP), exposing the stated form and amount to 90% relative humidity and 40° C. for one week and then taking the viscosity again at 121° C. (cP) (final viscosity). The change in viscosity is determined as a percentage by the following equation:

Viscosity Change (%)=(final viscosity−initial viscosity)/(initial viscosity)×100

Lower viscosity change indicates that moisture is not penetrating the individual form.

Heat Stability Test Method

A forced air oven was preheated to 121° C. An initial viscosity of the bulk material was taken, another portion (200 g) is melted into a 400 mL Beaker.

The filled beaker is placed into the preheated oven for 50 hours. After which, the viscosity is retaken and viscosity change is noted. The sample is further evaluated for any phase separation, or gel or char formation.

Viscosity Change (%)=(final viscosity−initial viscosity)/(initial viscosity)×100

Mettler Softening Point Test Method

The Mettler Softening Point is determined per ASTM D-3461 entitled, “Standard Test Method for Softening Point of Asphalt and Pitch (Mettler Cup and Ball Method),” with a heating rate of 4° C. per minute.

Tank Build Up Test Method

An Illinois Tool Works (ITW) Grid Melter was set to the following temperatures: glue pot, upper grid and hoses at 121° C.

5-kg of moisture sensitive hot melt composition in individual forms was placed in the tank.

The material was heated until molten.

The material was discharged from the tank.

A second, 5-kg of moisture sensitive hot melt composition in individual forms was placed in the tank.

The material was heated until molten.

The material was discharged from the tank.

The tank was evaluated and any build-up was noted.

TABLE ONE
Humidity Resistance

| | | | | Example 1 |
|---|---|---|---|---|
| | | | | (300 g of NW1700 |
| | | | | coextruded |
| | | | | pillows (50-60 |
| | | | | grams each), |
| | | | Control 3 | including 4.8% by |
| | | Control 2 | (300 g of NW1705 | weight of Outer |
| | | (2.3 kg of NW1705, | coextruded pillows | shell 1, the pillows |
| | | in release coated | (7-10 grams each), | including a 6 mm |
| | Control 1 | cake box) | including 3% by | (extending outward |
| | (2.3 kg of NW1705, | Cake box placed | weight of Outer | from the body of the |
| | in release coated | within zip lock | shell 1, knife cut, no | form) sealed zone |
| | cake box) | sealed foil bag | sealed zone) | on opposing ends |
| Viscosity | 77% | 23% | 99% | 9% |
| Change (%) | | | | |

TABLE TWO
Heat Stability

| | Control 1 | Example 2 | Example 3 |
|---|---|---|---|
| NW1705 - weight % | 100 | 95.2 | 95.2 |
| Outer shell 1 - weight % | | 4.8 | |
| EVA (18-500) - weight % | | | 4.8 |
| | No separation, | No separation, | No separation, |
| | no gel or char | no gel or char | no gel or char |
| | formation | formation | formation |
| Initial Viscosity | 1338 | 883 | 1275 |
| Viscosity after 50 hours at | 755 | 768 | 860 |
| 120° C. | | | |
| Viscosity change (%) | −44% | −13% | −33% |

Outer shell 1 includes 39.6% by weight hydrogenated micro wax (Shell Microcrystalline Wax HMP, Shell Chemical Company), 34.8% by weight of cycloaliphatic hydrocarbon resin tackifing agent (ESCOREZ 5415, Exxon Mobil Company), 25% by weight of styrene ethylene butylene styrene block copolymer (KRATON G1652, Kraton Corporation) and 0.6% by weight antioxidant.

TABLE THREE
Mettler Softening Point

| | |
|---|---|
| NW1705 | 56.7° C. (134° F.) |
| NW1700 | 67.8° C. (154° F.) |
| Outer shell 1 | 120° C. (248° F.) |
| EVA (18-500) | 90.5° C. (195° F.) |

### Tank Build-Up Test

NW1700 was coextruded with 4.8% by weight of Outer shell 1 on a JPB pillowing line to form pillows of about 50-60 grams each. Each pillow had a sealed zone that extended about 6 millimeters outward from the body of the form on each end. The pillows were tested per the Tank Build-up Test. No build-up was noted.

Other embodiments are within the claims.

What is claimed is:

1. A moisture sensitive hot melt composition in individual forms, the individual forms comprising:
a. a core of moisture sensitive hot melt composition, and
b. an outer shell comprising a thermoplastic polymer,
wherein the individual forms include a sealed zone of outer shell material, extending outward from the body of the individual forms, on at least two opposing sides of the individual forms.

2. The moisture sensitive hot melt composition in individual forms of claim 1 wherein the individual forms are selected from the group consisting of a pillow, a sausage and a slug.

3. The moisture sensitive hot melt composition in individual forms of claim 1 wherein the outer shell is coextruded with the moisture sensitive hot melt composition.

4. The moisture sensitive hot melt composition in individual forms of claim 1, wherein the moisture sensitive hot melt composition is selected from the group consisting of remoistenable, repulpable, compostable, hygroscopic, pH indicating, moisture indicating and moisture absorbing.

5. The moisture sensitive hot melt composition in individual forms of claim 1, wherein the moisture sensitive hot melt composition is selected from the group consisting of a hot melt wetness indicator composition and a hot melt moisture absorbent polymer composition.

6. The moisture sensitive hot melt composition in individual forms of claim 1 wherein the moisture sensitive hot melt composition is a wetness indicator composition.

7. The hot melt wetness indicator composition of claim 6 comprising an indicator selected from the group consisting of a pH indicator and a moisture indicator.

8. The hot melt wetness indicator composition of claim 6 comprising an indicator selected from the group consisting of bromocresol green, bromophenol blue and leuco dye.

9. The moisture sensitive hot melt composition in individual forms of claim 1 wherein the moisture sensitive hot melt composition is a hot melt moisture absorbent polymer composition.

10. The hot melt moisture absorbent polymer composition of claim 9 comprising from 10% by weight to 65% by weight of a moisture absorbent polymer.

11. The moisture sensitive hot melt composition in individual forms of claim 1 wherein the outer shell has a Mettler Softening Point of no greater than 16.7° C. of the application temperature of the moisture sensitive hot melt composition.

12. The moisture sensitive hot melt composition in individual forms of claim 1 where the outer shell comprises from 2% by weight to 7% by weight of the moisture sensitive hot melt composition in individual forms.

13. The moisture sensitive hot melt composition in individual forms of claim 1 where the outer shell comprises from 3% by weight to 6% by weight of the moisture sensitive hot melt composition in individual forms.

14. The moisture sensitive hot melt composition in individual forms of claim 1 wherein the individual forms each weigh from 5 grams to 1000 grams.

15. The moisture sensitive hot melt composition in individual forms of claim 1, wherein the individual forms each weight from 15 grams to 400 grams.

16. The moisture sensitive hot melt composition in individual forms of claim 1, wherein the thermoplastic polymer is selected from the group consisting of styrene block copolymer and ethylene polymer.

17. The moisture sensitive hot melt composition in individual forms of claim 1, wherein the sealed zone is at least 1 millimeters (mm) in length extending outward from the body of the form.

18. The moisture sensitive hot melt composition in individual forms of claim 1 wherein the sealed zone is from 2 mm to 10 mm in length extending outward from the body of the form.

19. The moisture sensitive hot melt composition in individual forms of claim 1, wherein the sealed zone of the outer shell material extends at least 0.5 mm outward from the body of the individual forms, on at least two opposing sides of the individual forms, and wherein the individual forms each weigh from 15 grams to 1000 grams.

20. Coextruded individual forms of moisture sensitive hot melt composition, obtained by a process wherein the moisture sensitive hot melt composition (a) is pumped through a coextrusion head and wherein the outer shell (b) is coextruded with the hot melt composition (a) such that the outer shell surrounds the hot melt composition, and then separating the coextruded material into individual forms by a method selected from the group consisting of pinching, pressing and heat sealing.
